(19) United States
(12) Patent Application Publication
(10) Pub. No.: US 2009/0296409 A1
(43) Pub. Date: Dec. 3, 2009

(54) LIGHT SOURCE DEVICE

(75) Inventor: TSUNG-YU LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,807

(22) Filed: Dec. 30, 2008

(30) Foreign Application Priority Data
May 28, 2008 (CN) 200810301801.6

(51) Int. Cl. F21V 8/00; F21V 33/00

(52) U.S. Cl. 362/311.06; 362/311.01; 362/355

(57) ABSTRACT

A light source device includes a light conduction component, a light source and light diffusion components. The light conduction component has a first surface and a second surface opposite to the first surface. The second surface has a light incidence portion. The first surface has a first portion and a second portion. The first portion is substantially coaxial with the light incidence portion and surrounded by the second portion. The light source is configured to emit lights to the light incidence portion. The light diffusion components are positioned on the second portion.

### CROSS-REFERENCE STATEMENT

This application is related to a co-pending U.S. patent application (Attorney Docket No. US19753), entitled “LIGHT SOURCE DEVICE”, invented by Tsung-Yu Lin. Such application has the same inventor and assignee as the present application.

### BACKGROUND

1. Technical Field

The disclosure relates to a light source device.

2. Description of Related Art

Nowadays, planar light sources are widely used in light source devices. When the planar light sources are positioned on the glass substrates, part of lights emitted from the planar light sources will be totally refracted at peripheral portions of the substrates, which decreases brightness of the illumination devices.

A typical light source device includes a planar light source, a light conduction component, and a plurality of pyramid-shaped prisms. The light conduction component is positioned between the planar light source and the pyramid-shaped prisms. The pyramid-shaped prisms can avoid total refraction of light occurring at peripheral portions of the light conduction component. However, total refraction may occur at a central portion of the light conduction component, which decreases brightness of the central portion.

Therefore, a new light source device is desired to overcome the above-described shortcoming.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cross-sectional view of one embodiment of a light source device.

FIG. 2 is a graph showing a relation between light incidence angle and brightness of the light source device of FIG. 1.

FIG. 3 is a cross-sectional view of another embodiment of a light source device.

FIG. 4 is a graph showing a relation between light incidence angle and brightness of the light source device of FIG. 3.

### DETAILED DESCRIPTION OF THE EMBODIMENTS

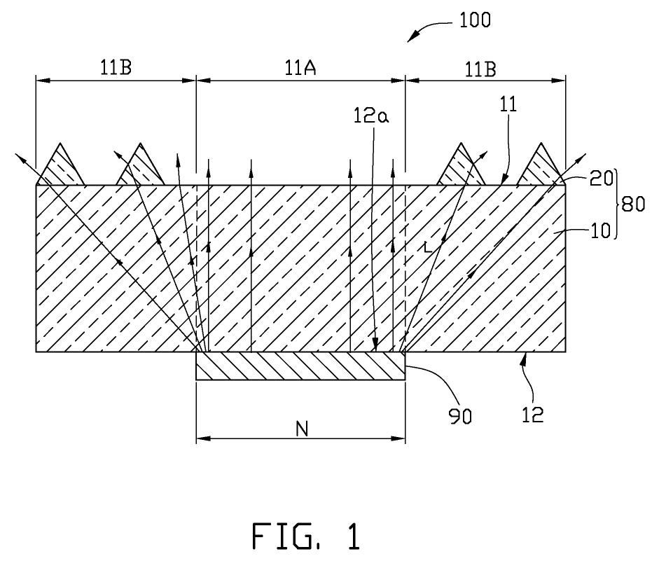

Referring to FIG. 1, one embodiment of a light source device 100 includes a light guide member 80 and a planar light source 90. The light guide member 80 includes a light conduction component 10 and a plurality of light diffusion components 20.

The planar light source 90 may be circular-shaped or may be rectangular shaped. In one embodiment, the planar light source 90 is square-shaped and has a width N of about 170 micrometers. The planar light source 90 includes a plurality of organic light emitting diodes.

The light conduction component 10 distributes lights emitted from the planar light source 90. The light conduction component 10 includes a first surface 11 and a second surface 12 opposite and substantially parallel to the first surface 11. The second surface 12 has a light incidence portion 12a located on a central portion of the light conduction component 10. The cross-section of the light incidence portion 12a is substantially identical to the cross-section of the planar light source 90. The planar light source 90 is positioned on the light incidence portion 12a. In one embodiment, the light incidence portion 12a is square-shaped and has a width of about 170 micrometers. The first surface 11 has a first portion 11A and a second portion 11B. The first portion 11A is substantially coaxial with and identical to the light incidence portion 11a. The second portion 11B surrounds the first portion 11A.

The plurality of light diffusion components 20 is positioned on the second portion 11B. Each light diffusion component 20 may be a pyramid-shaped prism and has a refractive index substantially equal to the refractive index of the light conduction component 10. In one embodiment, the base of each light diffusion component 20 is substantially quadrilateral, and has a width of about 50 micrometers and an apex angle of about 60 degrees. The plurality of light diffusion components 20 has a fill factor of about 69.4% on the first surface 11. The light conduction component 10 may be made of a transparent material such as a glass material. The light diffusion component 20 may be made of polymethylmethacrylate (PMMA).

In use, the planar light source 90 emits lights to the light incidence portion 12a. The lights are distributed by the light conduction component 10. The distributed lights are transmitted out the light conduction component 10 from the first portion 11A, and transmitted to the light diffusion component 20 from the second portion 11B. The light diffusion component 20 diffuses the distributed lights.

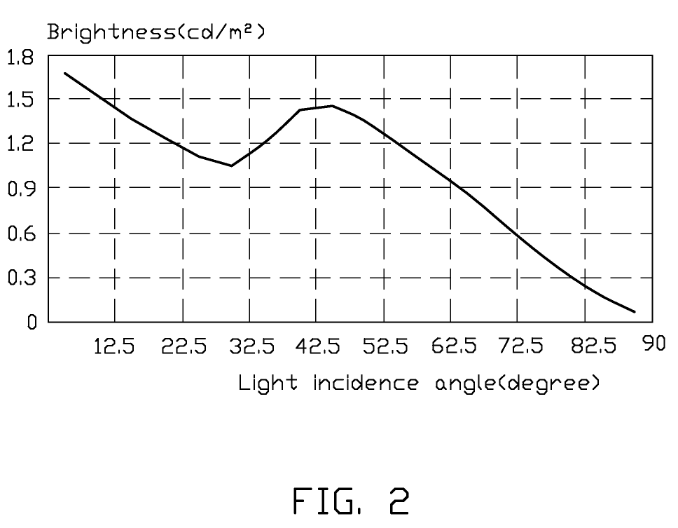

Referring to FIG. 2, a lateral axis represents light incidence angle. A longitudinal axis represents brightness of the light source device 100. As shown in FIG. 2, the light source device 100 has a high brightness at the light incidence angle from about zero degrees to about 72.5 degrees.

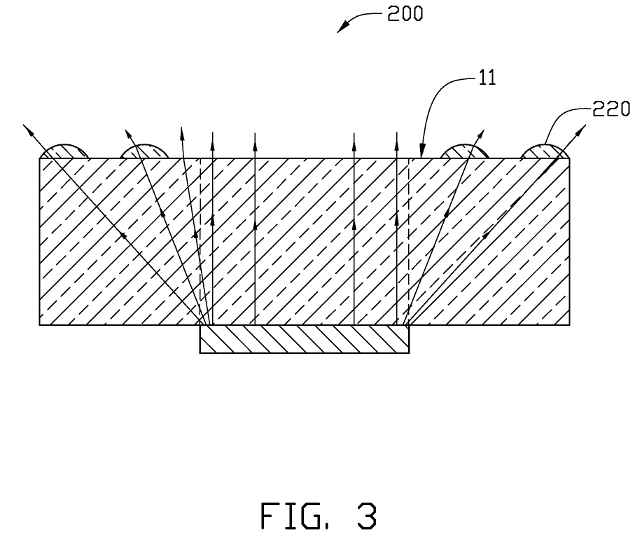

Referring to FIG. 3, another embodiment of a light source device 200 is similar to the light source device 100 of FIG. 1, except that each light diffusion component 220 may be a sphere-shaped lens. In one embodiment, the base of each sphere-shaped lens 220 has a diameter of about 50 micrometers. The plurality of sphere-shaped lenses 220 has a fill factor of about 54.54% on the first surface 11.

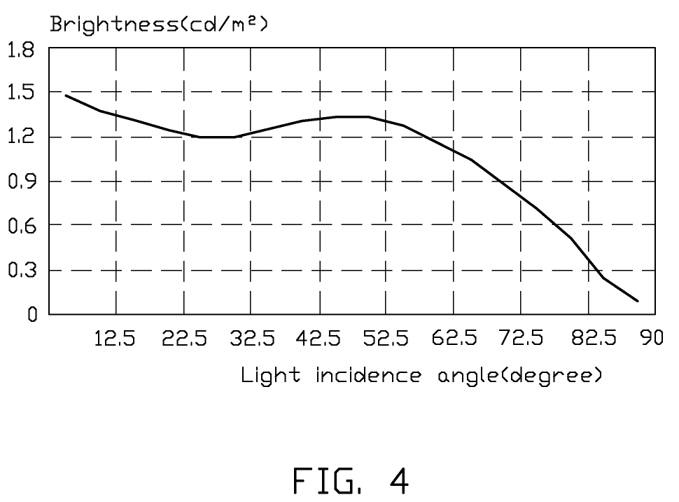

Referring to FIG. 4, a lateral axis represents light incidence angle. A longitudinal axis represents brightness of the light source device 200. As shown in FIG. 4, the light source device 200 has a high brightness at the light incidence angle from about zero degrees to about 72.5 degrees.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A light source device, comprising:
a light conduction component having a first surface and a second surface opposite to the first surface, the second surface having a light incidence portion, the first surface having a first portion and a second portion, the first portion being substantially coaxial with the light incidence portion and surrounded by the second portion;
a light source configured to emit light to the light incidence portion; and
a plurality of light diffusion components positioned on the second portion.

2. The light source device of claim 1, wherein the first surface is substantially parallel to the second surface.

3. The light source device of claim 1, wherein the light incidence portion is square-shaped and has a width of about 170 micrometers.

4. The light source device of claim 1, wherein the first portion is substantially identical to the light incidence portion.

5. The light source device of claim 1, wherein the light source is positioned on the light incidence portion.

6. The light source device of claim 1, wherein the light source is a planar light source.

7. The light source device of claim 6, wherein the light source is square-shaped and has a width of about 170 micrometers.

8. The light source device of claim 1, wherein each light diffusion component is a pyramid-shaped prism.

9. The light source device of claim 8, wherein the base of each light diffusion component is substantially quadrilateral and has a width of about 50 micrometers and an apex angle of about 60 degrees.

10. The light source device of claim 1, wherein each light diffusion component has a refractive index substantially equal to the refractive index of the light conduction component.

11. The light source device of claim 1, wherein each light diffusion component is a sphere-shaped lens.

12. The light source device of claim 11, wherein the base of each light diffusion component has a diameter of about 50 micrometers.

13. A light guide member for a light source device, comprising:
a light conduction component having a first surface and a second surface opposite and substantially parallel to the first surface, the second surface having a light incidence portion; the first surface having a first portion and a second portion, the first portion being substantially coaxial with the light incidence portion and surrounded by the second portion; and
a plurality of light diffusion components positioned on the second portion.

14. The light guide member of claim 13, wherein the light incidence portion is positioned on a central portion of the light conduction component.

15. The light guide member of claim 13, wherein the light incidence portion is square-shaped and has a width of about 170 micrometers.

16. The light guide member of claim 13, wherein the first portion is substantially identical to the light incidence portion.

17. The light guide member of claim 13, wherein each light diffusion component is a pyramid-shaped prism.

18. The light guide member of claim 17, wherein the base of each light diffusion component is substantially quadrilateral and has a width of about 50 micrometers and an apex angle of about 60 degrees.

19. The light guide member of claim 13, wherein each light diffusion component is a sphere-shaped lens.

20. The light guide member of claim 19, wherein the base of each light diffusion component has a diameter of about 50 micrometers.
